(19) United States
(12) Patent Application Publication
(10) Pub. No.: US 2024/0214270 A1
(43) Pub. Date: Jun. 27, 2024

(54) PROACTIVE SCALING IN A CONTAINERIZED ENVIRONMENT USING CONVERSATION TONES AND STORIES

(71) Applicant: INTERNATIONAL BUSINESS MACHINES CORPORATION, Armonk, NY (US)

(72) Inventors: Krishnan VENKITASUBRAMANIAN, Bengaluru (IN); Ramakrishna ALAVALA, Podili (IN); Sundaragopal VENKATRAMAN, Chennai (IN)

(21) Appl. No.: 18/085,953

(22) Filed: Dec. 21, 2022

(51) Int. Cl. H04L 41/08; G06F 40/279; G06F 40/30; H04L 41/0893

(52) U.S. Cl. CPC H04L 41/0879; G06F 40/279; G06F 40/30; H04L 41/0893

(57) ABSTRACT

A method includes: determining, by a processor set, a service availability impact and a user tone associated with a service by analyzing one or more electronic communications using natural language processing; determining, by the processor set, an impact urgency score based on the service availability impact and the user tone; determining, by the processor set, a scale-by value based on the impact urgency score; and scaling, by the processor set and based on the scale-by value, a computing cluster running a workload that provides the service. The method may include: creating a story that includes information defining the service, the impact urgency score, the scale-by value, and a date and time the scaling was performed; saving the story in a repository; identifying a pattern by analyzing plural stories saved in the repository as a time series; and proactively scaling the computing cluster running the workload based on the identified pattern.

### BACKGROUND

Aspects of the present invention relate generally to controlling computing operations in a containerized environment and, more particularly, to proactive scaling in a containerized environment using conversation tones and stories.

Schedulers in a containerized environment have the capability of scaling/scheduling pods based on various metrics. There are multiple parameters that a scheduler checks to arrive at an ideal node candidate for scheduling. These parameters may include priority, preemption, and a host of predicates.

### SUMMARY

In a first aspect of the invention, there is a computer-implemented method including: determining, by a processor set, a service availability impact and a user tone associated with a service by analyzing one or more electronic communications using natural language processing; determining, by the processor set, an impact urgency score based on the service availability impact and the user tone; determining, by the processor set, a scale-by value based on the impact urgency score; and scaling, by the processor set and based on the scale-by value, a computing cluster running a workload that provides the service.

In another aspect of the invention, there is a computer program product including one or more computer readable storage media having program instructions collectively stored on the one or more computer readable storage media. The program instructions are executable to: determine a service availability impact and a user tone associated with a service by analyzing one or more electronic communications using natural language processing; determine an impact urgency score based on the service availability impact and the user tone; determine a scale-by value based on the impact urgency score; and scale, based on the scale-by value, a computing cluster running a workload that provides the service.

In another aspect of the invention, there is system including a processor set, one or more computer readable storage media, and program instructions collectively stored on the one or more computer readable storage media. The program instructions are executable to: determine a service availability impact and a user tone associated with a service by analyzing one or more electronic communications using natural language processing; determine an impact urgency score based on the service availability impact and the user tone; determine a scale-by value based on the impact urgency score; and scale, based on the scale-by value, a computing cluster running a workload that provides the service.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows an exemplary service topology tree in accordance with aspects of the invention.

FIG. 4 shows an exemplary service topology table in accordance with aspects of the invention.

FIG. 5 shows an exemplary service availability keywords and impact mapping table in accordance with aspects of the invention.

FIG. 6 shows an exemplary tone mapping table in accordance with aspects of the invention.

FIG. 7 shows an exemplary updated impact score calculation table in accordance with aspects of the invention.

FIG. 8 shows an exemplary urgency range value placeholder in accordance with aspects of the invention.

FIG. 9 shows an exemplary urgency value mapping table in accordance with aspects of the invention.

FIG. 10 shows an exemplary impact urgency score calculation table in accordance with aspects of the invention.

FIG. 11 shows an exemplary priority score placeholder table in accordance with aspects of the invention.

FIG. 12 shows an exemplary priority score calculation table in accordance with aspects of the invention.

FIG. 13 shows an exemplary scaling recommendation table in accordance with aspects of the invention.

FIG. 14 shows an exemplary story in accordance with aspects of the invention.

FIG. 15 shows a flowchart of an exemplary method in accordance with aspects of the invention.

### DETAILED DESCRIPTION

Aspects of the present invention relate generally to controlling computing operations in a containerized environment and, more particularly, to proactive scaling in a containerized environment using conversation tones and stories. Pod scheduling in a containerized environment (e.g., in a Kubernetes cluster) is limited to the capabilities of the underlying scheduler. Current schedulers are capable of scheduling pods based on metrics (e.g., priority, preemption, etc.) or manual interventions. However, current schedulers are not intelligent enough to scale or schedule pods based on a user's emotional vocabulary. As a result, current schedulers fail to account for a user's emotional vocabulary when a user is attempting to notify the service provider of problems with an online service, and this results in user dissatisfaction with the service. Aspects of the invention address this problem by automatically scaling pods in a computing cluster based on an urgency determined from emotional vocabulary of user communications. In embodiments, the system continues analyzing the communications to detect an issue resolution and conversation tone change, at which point the system builds a resolution story and stores the story in a stories database. A story in this context can include information that defines an online service, issue, time, and the scaling performed. In embodiments, a learning behavior is induced based on a time-line view of the stories in the stories database. These stories may be used to derive times-series based patterns. In embodiments, the system performs proactive scaling based on these patterns.

Aspects of the invention address the above-noted problem by providing a containerized environment that automatically scales pods based on an urgency determined from emotional vocabulary of user communications. In embodiments, a scheduler (or other computing device) determines an online service, an availability of the online service, and an urgency regarding the availability of the online service by analyzing one or more electronic communications using natural language processing. Based on the urgency regarding the availability of the online service, the scheduler (or other computing device) determines a scaling recommendation. Based on the scaling recommendation, the scheduler scales a computing cluster running a workload that provides the online service. In this manner, implementations of the invention provide a technological solution (e.g., automatic scaling of pods in a containerized environment based on urgency determined from electronic communications) to the technological problem of current schedulers that make scheduling and scaling decisions that do not account for a user's emotional vocabulary.

Implementations of the invention, through a combination of user satisfaction tones and analysis of issues identified by users, add an artificial intelligence (AI) dimension for proactively scaling pods in a containerized environment by analyzing emotional vocabulary in electronic communications. In embodiments, a data store uses data collectors to gather details of all conversation happening about a particular service, such as an online banking service, for example. The conversations can include electronic communications from different channels such as helpdesk, social media, etc. In embodiments, an AI module proactively checks for keywords in the conversations and compares the keywords with internal repositories and emotional vocabulary such as straight talk keywords, soft language keywords, condemnation keywords, and exasperation keywords. In embodiments, when the AI module finds a keyword, the AI module scores the issue according to predefined scoring associations. In embodiments, the AI module takes into consideration repeat calls and repeat callers, and also takes into consideration any resolution that is reported or reduction in noise that is analyzed. In embodiments, the AI module identifies a service responsible for the conversation, scales pods supporting the service, and keeps analyzing the conversation at real time. In embodiments, an issue resolution and conversation tone change leads to a resolution story building that is stored in stories database. In embodiments, the AI module produces and analyzes a time-line view of the stories to arrive at patterns derived from the time series. In embodiments, the AI module uses these patterns for proactive scaling.

As described herein, implementations of the invention provide systems and methods for: arriving at service keywords mapping; mapping a service to tone of the user; story building using issue resolution and conversation tone changes; updating stories based on conversation tone changes and issue resolution; arriving at and also updating a time series based pattern view of the stories; mapping service availability keywords and scoring the mapping based on the conversation and tones; mapping service availability keywords to impact and urgency values and arriving at a priority based on these values; creating time line views of stories and arriving at time series based patterns based on these stories; using the time series based stories and story patterns for proactive scaling; and scaling based on issue resolution and conversation tone changes and mapping to stories.

It should be understood that, to the extent implementations of the invention collect, store, or employ personal information provided by, or obtained from, individuals (for example, information contained in electronic communications) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automatic scaling code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

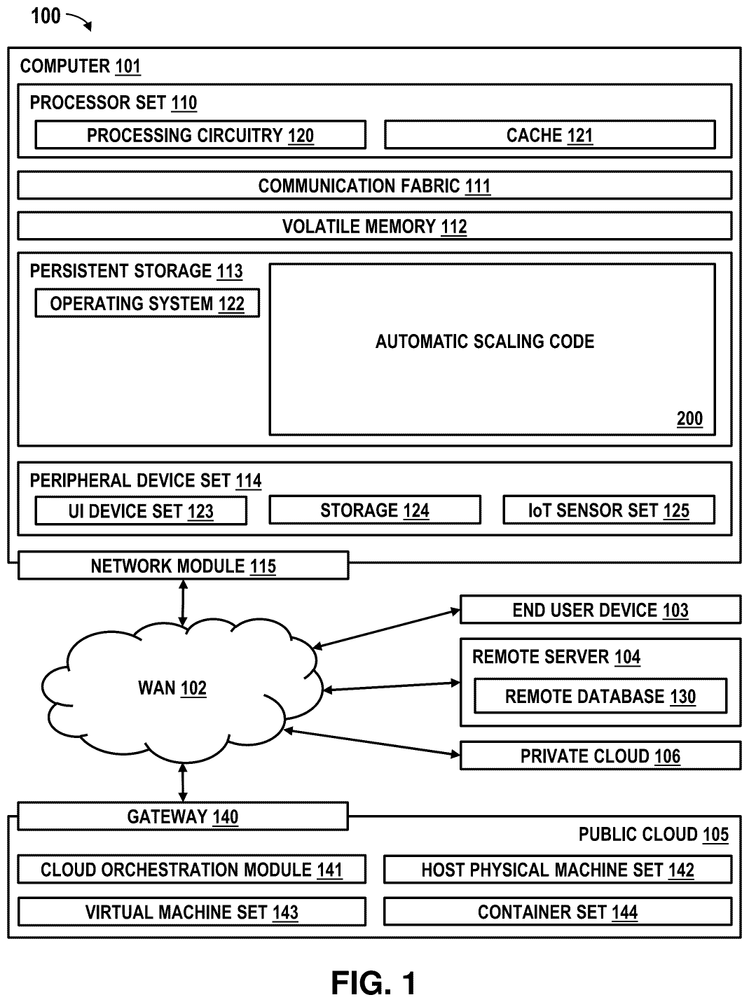

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

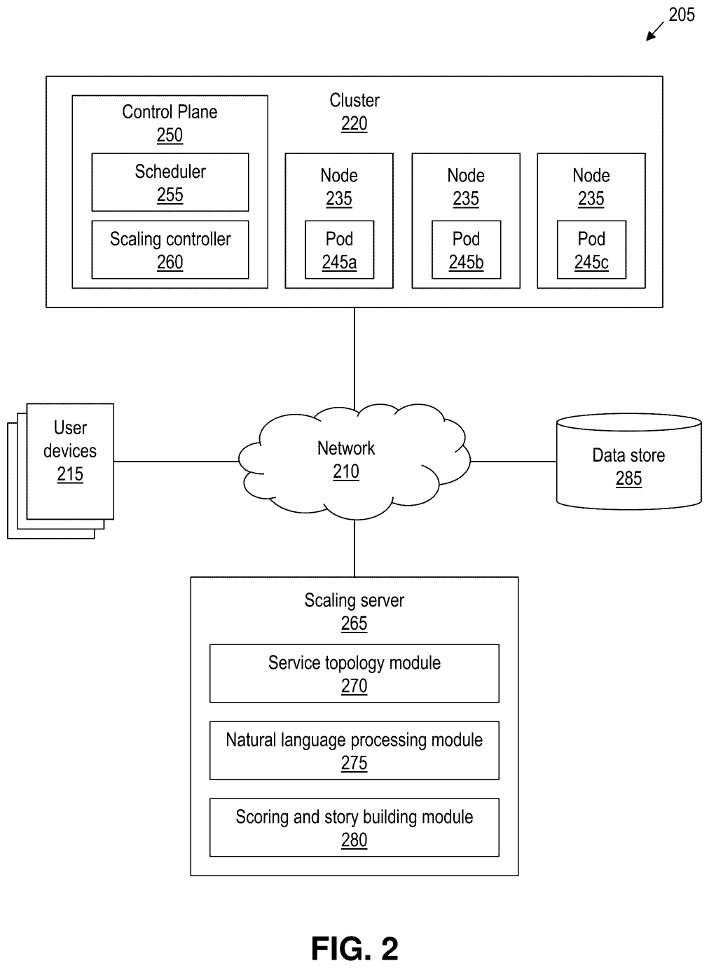

FIG. 2 shows a block diagram of an exemplary environment 205 in accordance with aspects of the invention. In embodiments, the environment 205 includes a network 210 that provides electronic communication between user devices 215 and a cluster 220 that provides online services to the user devices 215. The network 210 may correspond to the WAN 102 of FIG. 1. The user devices 215 may correspond to instances of end user device 103 of FIG. 1.

In embodiments, the cluster 220 is a computing cluster including nodes 235 that run containerized applications that provide online services to the user devices 215. In a particular example, the cluster 220 is a Kubernetes cluster. Each node 235 may comprise a computing device that hosts one or more pods 245a-c. As is understood in the art, pods contain one or more containers, such as Docker containers. The pods 245a-c run on nodes 235 and represent a single instance of a running process in the cluster 220. In the example shown in FIG. 2, one or more first pods 245a provide a first online service to the user devices 215. Similarly, one or more second pods 245b provide a second online service to the user devices 215, and one or more third pods 245c provide a third online service to the user devices 215. There are three nodes 235 shown in the example of FIG. 2; however, there may be any number of the nodes 235 in the cluster 220, and there may be any number of pods on each node. Plural pods associated with the same service may run on different nodes, and plural pods associated with different services may run on the same node.

Still referring to FIG. 2, the cluster 220 includes a control plane 250 that manages the nodes 235 and the pods 245a-c in the cluster 220. The control plane 250 includes a scheduler 255 that watches for newly created pods with no assigned node and selects a node for them to run on. In embodiments, the control plane 250 also includes a scaling controller 260 that is configured to scale a workload for a service to match demand for the service. In accordance with aspects of the invention, the scaling controller 260 may scale a workload for a service using horizontal scaling or vertical scaling. In horizontal scaling, the scaling controller 260 deploys more pods to handle a workload. In vertical scaling, the scaling controller 260 assigns more computing resources (e.g., memory, CPU, etc.) to pods that are already running a workload. For example, in response to determining there is an increased demand for a service provided by the pods 245a, the scaling controller 260 may either create additional instances of pods 245a to assist with the workload for this service (horizontal scaling) or allocate more computing resources to pods 245a that are currently running the workload for this service (vertical scaling).

In accordance with aspects of the invention, the environment 205 includes a scaling server 265 and a data store 285. The scaling server 265 may comprise one or more instances of computer 101 of FIG. 1. Alternatively, the scaling server 265 may comprise one or more instances of virtual machines (VMs) or containers running on one or more instances of computer 101 of FIG. 1. In one example, the scaling server 265 is separate from the cluster 220. In another example, the scaling server 265 is included in the cluster 220, for example as part of the control plane 250.

In embodiments, the scaling server 265 of FIG. 2 comprises a service topology module 270, a natural language processing module 275, and a scoring and story building module 280, each of which may comprise modules of the code of block 200 of FIG. 1. These modules of the code of block 200 are executable by the processing circuitry 120 of FIG. 1 to perform the inventive methods as described herein. The scaling server 265 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the service topology module 270 is configured to determine services provided by the cluster 220 to the user devices 215. In embodiments, the service topology module 270 utilizes one or more automated service discovery tools (e.g., software tools) to determine services provided by the cluster 220 to the user devices 215.

In accordance with aspects of the invention, the natural language processing module 275 is configured to analyze electronic communications to identify keywords in the electronic communications that match keywords defined in one or more data structures stored in the data store 285. In embodiments, the natural language processing module 275 uses one or more keyword extraction algorithms to identify predefined keywords in the electronic communications.

In accordance with aspects of the invention, the scoring and story building module 280 is configured to create scores and stories based on the keywords identified in the electronic communications, and to generate a scaling recommendation for the cluster 220 based on the scores and stories. In embodiments, the scoring and story building module 280 uses predefined relationships to assign scores to respective keywords and to combine individual scores to create aggregate scores. In embodiments, the scoring and story building module 280 uses predefined relationships to generate a scaling recommendation based on a determined score.

In accordance with aspects of the invention, the scoring and story building module 280 is configured to identify a pattern in a time series collection of stories and to generate a proactive scaling recommendation based on the identified pattern. In embodiments, the scoring and story building module 280 uses machine learning to identify a pattern in the time series data. In a particular example, the scoring and story building module 280 uses k-means clustering to identify the pattern in the time series data, where k-means clustering is a particular type of unsupervised machine learning.

With continued reference to FIG. 2, the data store 285 comprises data storage such as storage 124 or remote database 130 of FIG. 1. In embodiments, the data store 285 stores data including but not limited to a resolution story repository, a service topology repository, a service vocabulary repository, a service availability keyword repository, a tone keyword repository, an impact score mapping, an urgency score mapping, and a priority score mapping.

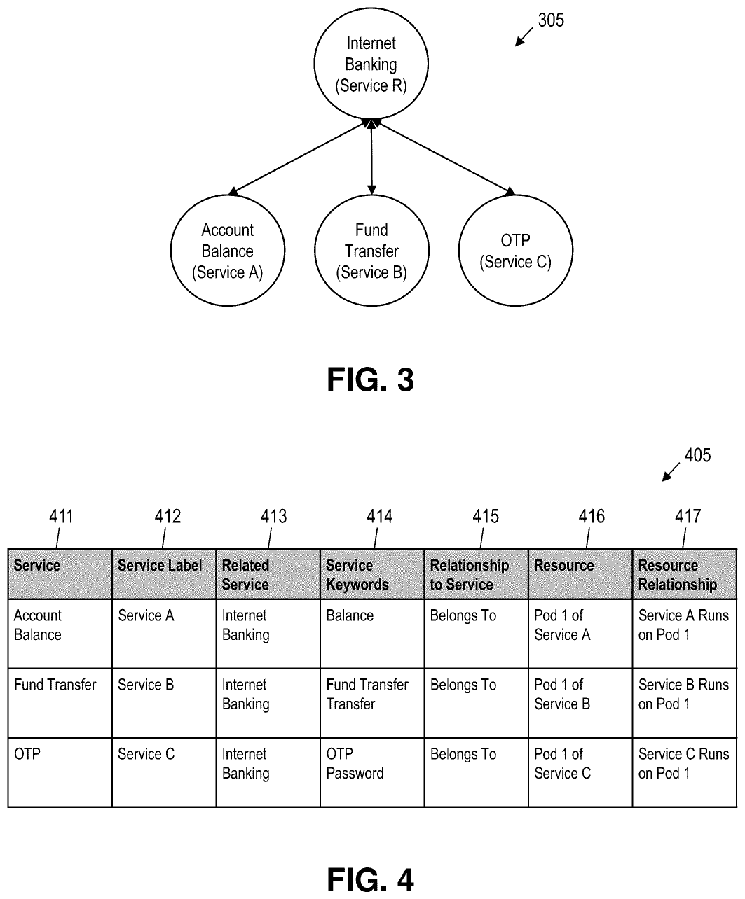

FIGS. 3-14 show an exemplary use case that illustrates aspects of the invention. Steps of the exemplary use case may be carried out in the environment of FIG. 2 and are described with reference to elements depicted in FIG. 2. The data shown in the various tables in FIGS. 3-14 is exemplary as is not intended to be limiting on implementations of the invention.

FIG. 3 shows an exemplary service topology tree 305 in accordance with aspects of the invention. In embodiments, the service topology module 270 of FIG. 2 uses one or more service topology discovery tools to discover services provided by the cluster 220 to the user devices 215. In this example, the service topology module 270 discovers that the cluster 220 provides Internet banking services to the user devices 215 (Service R), and that the Internet banking services include an account balance service (Service A), a fund transfer service (Service B), and a one-time password (OTP) service (Service C).

FIG. 4 shows an exemplary service topology table 405 in accordance with aspects of the invention. In embodiments, the service topology module 270 of FIG. 2 uses one or more service topology discovery tools to analyze the discovered services for the purpose of determining relationships that are populated in the service topology table 405. The service topology table 405 may be populated automatically by the service topology module 270 and may be updated manually (e.g., by a human user) to correct any errors in the automatically populated values to give a clear topology and dependency view. In this example, the service topology table 405 includes columns that define service 411, service label 412, related service 413, service keywords 414, relationship to service 415, resource 416, and resource relationship 417. For example, in the Account Balance row of the service topology table 405, it can be seen that the Account Balance service has the label Service A, is related to the Internet Banking service, has the related keyword Balance, and runs on Pod 1 (which, in this example, corresponds to pod 245a). The populated service topology table 405 may be stored in the data store, e.g., in a service topology repository.

Still referring to FIG. 4, in accordance with aspects of the invention, the service keywords 414 are words that are associated with a respective service (e.g., Service A, Service B, Service C, etc.), and that are used by the natural language processing module 275 to determine that an electronic communication is directed to a particular one of the services. For example, an electronic communication may be deemed as being related to the Account Balance service based on the natural language processing module 275 detecting the word “balance” in the electronic communication. The data store 285 may store information regarding the service keywords 414, e.g., in a service vocabulary repository.

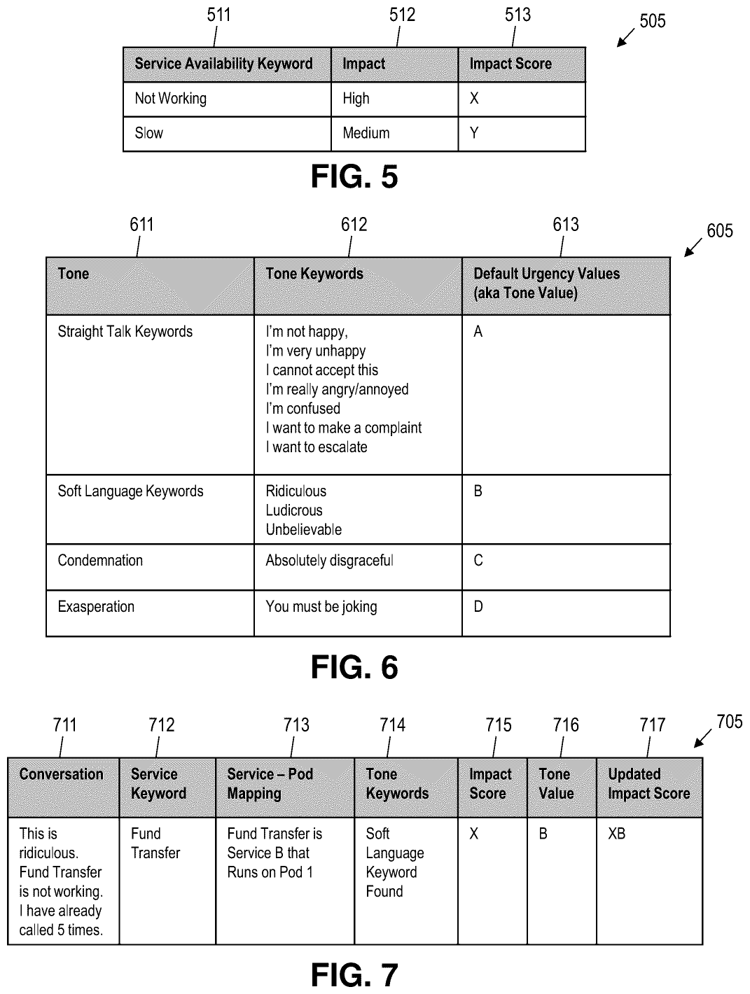

FIG. 5 shows an exemplary service availability keywords and impact mapping table 505 in accordance with aspects of the invention. In embodiments, the scaling server 265 stores a list of service availability keywords in the data store 285, e.g., in a service availability keyword repository. The service availability keywords are words that are associated with level of availability of a service and are used by the natural language processing module 275 to determine that an electronic communication is describing a particular level of availability of a service. Non-limiting examples of service availability keywords are “slow” and “not working” and “broken”. As shown in FIG. 5, the service availability keywords and impact mapping table 505 stores information on common ones of the service availability keywords, as shown at column 511, and their impact mapping with respect to the service, as shown at column 512. The service availability keywords and impact mapping table 505 also includes an impact score for each service availability keyword, as shown at column 513. The impact scores in column 513 can be user-defined values, such as numeric values.

FIG. 6 shows an exemplary tone mapping table 605 in accordance with aspects of the invention. In embodiments, the tone mapping table 605 defines relationships between different tones shown in column 611, tone keywords shown in column 612, and tone values shown in column 613. The tone keywords 612 are words that are associated with a respective tone (e.g., straight talk, soft language, condemnation, exasperation, etc.), and that are used by the natural language processing module 275 to determine that an electronic communication has one of the respective tones. For example, an electronic communication may be deemed as having a tone of soft language based on the natural language processing module 275 detecting the word “ridiculous” in the electronic communication. The data store 285 may store the tone mapping table 605, e.g., in a tone keyword repository. The tone values in column 613 can be user-defined values, such as numeric values.

FIG. 7 shows an exemplary updated impact score calculation table 705 in accordance with aspects of the invention. Column 711 includes content of an electronic communication about an online service provided by the cluster 220 of FIG. 2. Column 712 includes a service keyword (e.g., fund transfer) detected by the natural language processing module 275 in the electronic communication. Based on the detected service keyword at column 712, the scoring and story building module 280 uses the service topology table 405 to determine the service to pod mapping shown in column 713. Column 714 indicates a tone of the electronic communication determined using the tone mapping table 605 with a tone keyword (e.g., ridiculous) detected in the electronic communication. Column 715 indicates an impact score of the electronic communication determined using the service availability keywords and impact mapping table 505 and a service availability keyword (e.g., not working) detected in the electronic communication. Column 716 indicates a tone value of the electronic communication determined using the tone mapping table 605 and the determined tone. Column 717 includes an updated impact score of the electronic communication. In embodiments, the scoring and story building module 280 determines the updated impact score based on the impact score from column 715 and the tone value from column 716. The scoring and story building module 280 may be programed with a suitable function for determining the updated impact score based on the impact score and the tone value. In one example, the function is a product of the impact score and the tone value. In another example, the function is a sum of the impact score and the tone value. In another example, the function is a concatenation of the impact score and the tone value.

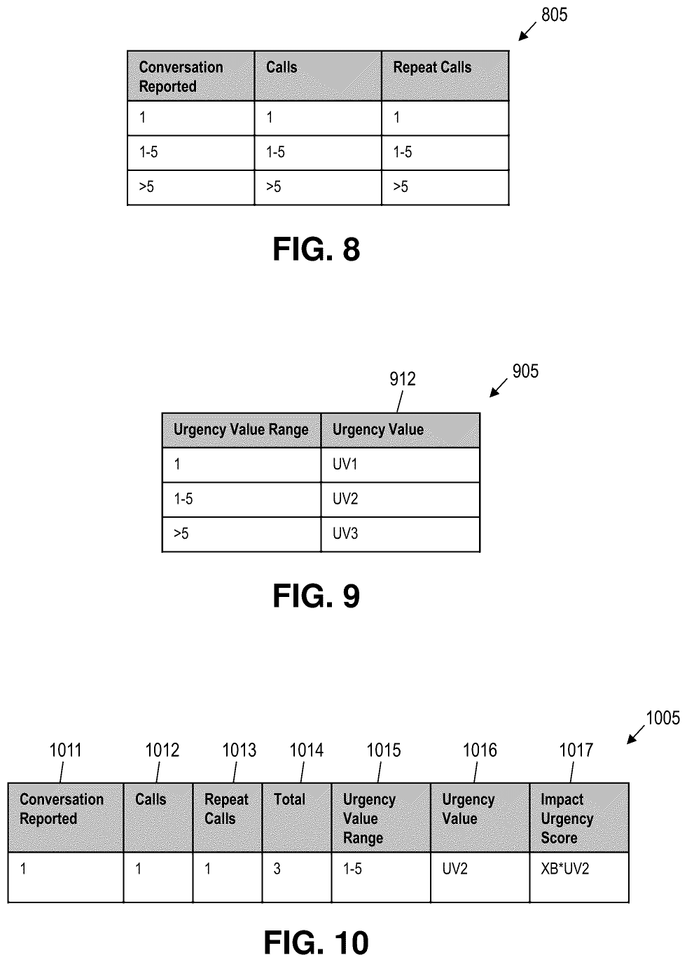

FIG. 8 shows an exemplary urgency range value placeholder 805 and FIG. 9 shows an exemplary urgency value mapping table 905 in accordance with aspects of the invention. In embodiments, the scoring and story building module 280 updates the urgency range value placeholder every time there is a new electronic communication such as a conversation reported via any type of communication channel, a call, or a repeat call. In embodiments, the scoring and story building module 280 uses the urgency range value placeholder to determine an urgency value from the urgency value mapping table 905. In this manner, different numbers of electronic communications about a service can result in different urgency values based on the relationships defined in the urgency value mapping table 905. The urgency values in column 912 can be user-defined values, such as numeric values. The urgency value mapping table 905 may be stored in the data store 285.

FIG. 10 shows an exemplary impact urgency score calculation table 1005 in accordance with aspects of the invention. In the example of FIG. 10, there has been one conversation reported (as indicated at column 1011), one call (as indicated at column 1012), and one repeat call (as indicated at column 1013). Based on columns 1011, 1012, and 1013, there are a total of 3 communications indicated at column 1014. In this example, the scoring and story building module 280 determines an urgency value range of 1-5 (shown at column 1015) and an urgency value UV2 (shown at column 1016) based on the total of 3 from column 1014 and the urgency value mapping table 905. Column 1017 includes an impact urgency score. In embodiments, the scoring and story building module 280 determines the impact urgency score based on the updated impact score from column 717 and the urgency value from column 1016. The scoring and story building module 280 may be programed with a suitable function for determining the impact urgency score based on the updated impact score and the urgency value. The impact urgency score determined in this manner is a function of a determined service availability (e.g., via the impact score used to determine the updated impact score), a determined tone (e.g., via the tone value used to determine the updated impact score), and a determined urgency (e.g., via the urgency value), all of which are determined based on analyzing electronic communications about the service.

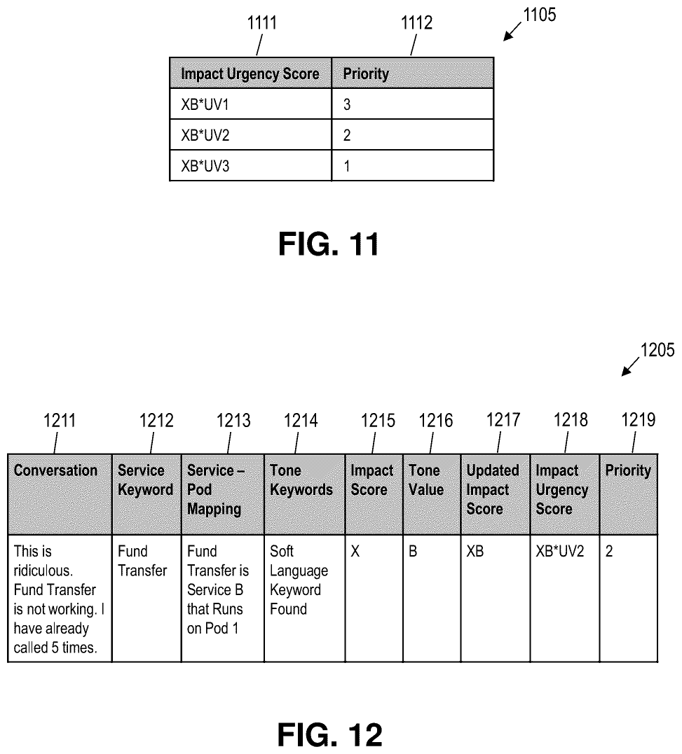

FIG. 11 shows a priority score placeholder table 1105 in accordance with aspects of the invention. In embodiments, the priority score placeholder table 1105 maps different impact urgency scores (at column 1111) to priority scores (at column 1112). The priority scores in column 1112 can be user-defined values, such as numeric values. The priority score placeholder table 1105 shows only a subset of the different impact urgency scores that are possible in the exemplary use case.

FIG. 12 shows an exemplary priority score calculation table 1205 in accordance with aspects of the invention. Columns 1211-1217 of the priority score calculation table 1205 correspond to columns 711-717, respectively, of the updated impact score calculation table 705. Column 1218 of the priority score calculation table 1205 indicates the impact urgency score from column 1017 of the impact urgency score calculation table 1005. Column 1219 of the priority score calculation table 1205 indicates the priority determined from the priority score placeholder table 1105 and based on the impact urgency score.

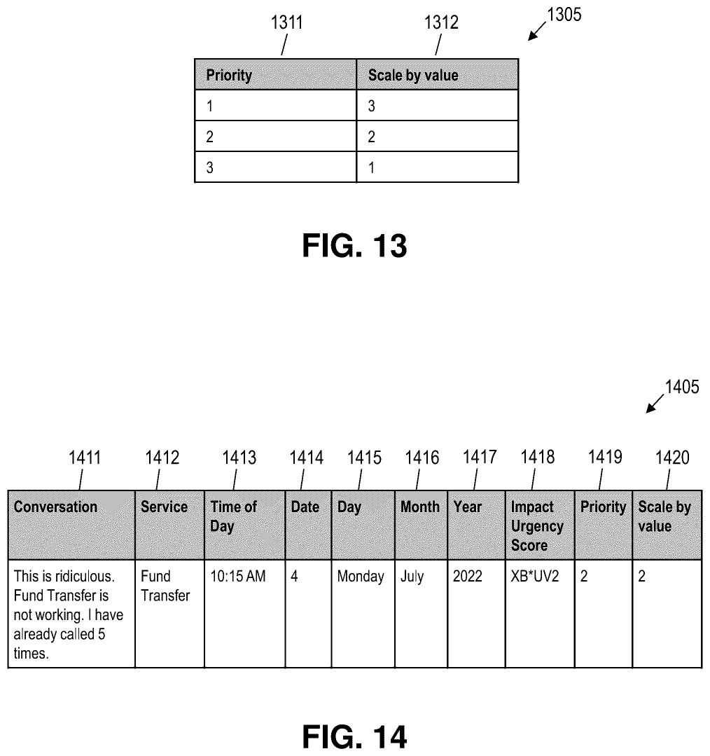

FIG. 13 shows a scaling recommendation table 1305 in accordance with aspects of the invention. In embodiments, the scaling recommendation table 1305 maps different priority scores (at column 1311) to scale-by values (at column 1312). In embodiments, the scale-by values in column 1312 comprise numeric values that the cluster 220 uses to scale the pods handling the service, e.g., as indicated at the service to pod mapping at column 1213 of the priority score calculation table 1205 of FIG. 12. In this particular example, using the information in priority score calculation table 1205 of FIG. 12 and the corresponding scale-by value determined using the scaling recommendation table 1305, the scaling controller 260 of the control plane 250 would scale the pods running the Fund Transfer service (e.g., Service B). The scaling could be horizontal scaling or vertical scaling and would be performed in an amount based on the scale-by value. The scale-by values in column 1312 can be user-defined values, such as numeric values. In this manner, the scaling recommendation table 1305 constitutes a predefined relationship that equates respective priority scores to respective scale-by values. The scale-by values in column 1312 can be updated over a period of time. The updating can be performed manually, e.g., based on user feedback indicating the service did not improve after performing scaling according to the scale-by value. The updating can be performed automatically, e.g., based on analyzing whether the scaling performed according to the scale-by value was followed by increased scaling. In this manner, implementations of the invention adjust one or more of the respective scale-by values in the predefined relationship (i.e., in the scaling recommendation table 1305) based on feedback regarding the scaling the computing cluster

FIG. 14 shows a story 1405 in accordance with aspects of the invention. In embodiments, the scoring and story building module 280 creates the story 1405, e.g., when a resolution occurs with the service that is the subject of the electronic communications. The resolution may comprise closing a help desk ticket or a service ticket, for example. In embodiments, the story 1405 is a data structure that stores information about the content of the electronic communication (column 1411), the determined service (column 1412), the time of day the scaling was performed (column 1413), the date, day, month, and year the scaling was performed (columns 1413-1417), the impact urgency score (column 1418), the priority (column 1419), and the scale-by value applied (column 1420). In embodiments, the scoring and story building module 280 stores the story 1405 in the data store 285.

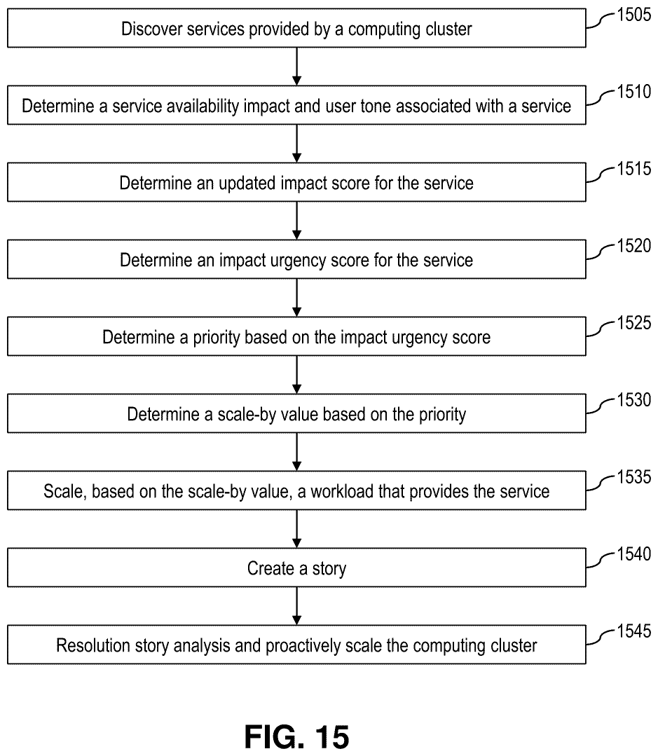

FIG. 15 shows a flowchart of an exemplary method in accordance with aspects of the present invention. Steps of the method may be carried out in the environment of FIG. 2 and are described with reference to elements depicted in FIG. 2.

At step 1505, the system discovers services provided by a computing cluster. In embodiments, and as described with respect to FIGS. 2-4, the service topology module 270 discovers services provided by cluster 220 and maps the services in a service topology table 405.

At step 1510, the system determines a service availability impact and a user tone associated with one of the discovered services provided by the cluster 220. In embodiments, and as described with respect to FIG. 4-7, the natural language processing module 275 analyzes one or more electronic communications to detect a service keyword, a service availability keyword, and a tone keyword. Based on the detected service availability keyword, the system determines a service availability impact using a service availability keywords and impact mapping table 505. Based on the detected tone keyword, the system determines a user tone (e.g., tone at column 611) using a tone mapping table 605.

At step 1515, the system determines an updated impact score for the service. In embodiments, and as described with respect to FIG. 4-7, the scoring and story building module 280 uses the detected service keyword with the service topology table 405 to determine the service. Moreover, the scoring and story building module 280 uses the detected service availability keyword with the service availability keywords and impact mapping table 505 to determine an impact score. Furthermore, the scoring and story building module 280 uses the detected tone keyword with the tone mapping table 605 to determine a tone value. As described with respect to FIG. 7, the scoring and story building module 280 uses determined impact score and the determined tone value to determine an updated impact score for this service.

At step 1520, the system determines an impact urgency score for the service determined at step 1515. In embodiments, and as described with respect to FIG. 8-10, the scoring and story building module 280 uses an urgency value mapping table 905 to determine an urgency value based on a sum of conversations reported, calls, and repeat calls about this service. In embodiments, the scoring and story building module 280 determines the impact urgency score based on the updated impact score (from step 1515) and the urgency value from the urgency value mapping table 905.

At step 1525, the system determines a priority based on the impact urgency score from step 1520. In embodiments, and as described with respect to FIGS. 11 and 12, the scoring and story building module 280 uses a priority score placeholder table 1105 to determine a priority based on the impact urgency score from step 1520.

At step 1530, the system determines a scale-by value based on the priority from step 1525. In embodiments, and as described with respect to FIGS. 13 and 14, the scoring and story building module 280 uses a scaling recommendation table 1305 to determine a scale-by value based on the priority from step 1525.

At step 1535, the system scales a workload that provides the service based on the scale-by value from step 1530. In embodiments, and as described herein, the scaling controller 260 scales pods that provide the service determined at step 1515 based on the scale-by value determined at step 1530. The scaling may be horizontal scaling or vertical scaling. In this manner, the system allocates more computing resources to provide the service.

At step 1540, the system creates a story. In embodiments, and as described with respect to FIGS. 13 and 14, the scoring and story building module 280 creates a story 1405 that stores information about the service determined at step 1515, the time of day, date, day, month, and year the scaling was performed, the impact urgency score determined at step 1520, the priority determined at step 1525, and the scale-by value determined at step 1530. Step 1540 may include the scoring and story building module 280 saving the story 1405 in a data store 285.

At step 1545, the system performs resolution story analysis and proactively scales the cluster. In embodiments, and as described with respect to FIG. 2, the scoring and story building module 280 identifies a pattern in a time series collection of plural stories that are saved in the data store 285. In embodiments, the scoring and story building module 280 generates a proactive scaling recommendation based on the identified pattern. In embodiments, the scoring and story building module 280 communicates the proactive scaling recommendation to the scaling controller 260, which then performs the scaling based on the proactive scaling recommendation.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, by a processor set, a service availability impact and a user tone associated with a service by analyzing one or more electronic communications using natural language processing;
determining, by the processor set, an impact urgency score based on the service availability impact and the user tone;
determining, by the processor set, a scale-by value based on the impact urgency score; and
scaling, by the processor set and based on the scale-by value, a computing cluster running a workload that provides the service.

2. The method of claim 1, wherein the impact urgency score is additionally based on an urgency value derived from a total number of the one or more electronic communications.

3. The method of claim 1, wherein the analyzing one or more electronic communications comprises detecting a service keyword, a service availability keyword, and a tone keyword in the one or more electronic communications.

4. The method of claim 1, wherein the one or more electronic communications include communications selected from a group consisting of: email; telephone call; help desk ticket; online chat; and social media message.

5. The method of claim 1, further comprising:
creating a story comprising a data structure that includes information defining the service, the impact urgency score, the scale-by value, and a date and time the scaling was performed; and
saving the story in a repository.

6. The method of claim 5, further comprising:
identifying a pattern by analyzing plural stories saved in the repository as a time series; and
proactively scaling the computing cluster running the workload based on the identified pattern.

7. The method of claim 1, wherein the determining the scale-by value comprises:
determining a priority score based on the impact urgency score; and
determining the scale-by value based on the priority score using a predefined relationship that equates respective priority scores to respective scale-by values.

8. The method of claim 7, further comprising adjusting one or more of the respective scale-by values in the predefined relationship based on feedback regarding the scaling the computing cluster.

9. The method of claim 1, wherein:
the workload comprises a containerized application;
the computing cluster comprises nodes that run the containerized application;
the nodes host pods that run one or more containers of the containerized application; and
the scaling comprises deploying one or more additional pods running one or more additional containers of the containerized application.

10. The method of claim 1, wherein:
the workload comprises a containerized application;
the computing cluster comprises nodes that run the containerized application;
the nodes host pods that run one or more containers of the containerized application; and
the scaling comprises allocating additional computing resources to existing pods running the one or more containers of the containerized application.

11. A computer program product comprising one or more computer readable storage media having program instructions collectively stored on the one or more computer readable storage media, the program instructions executable to:
determine a service availability impact and a user tone associated with a service by analyzing one or more electronic communications using natural language processing;
determine an impact urgency score based on the service availability impact and the user tone;
determine a scale-by value based on the impact urgency score; and
scale, based on the scale-by value, a computing cluster running a workload that provides the service.

12. The computer program product of claim 11, wherein the impact urgency score is additionally based on an urgency value derived from a total number of the one or more electronic communications.

13. The computer program product of claim 11, wherein the analyzing one or more electronic communications comprises detecting a service keyword, a service availability keyword, and a tone keyword in the one or more electronic communications.

14. The computer program product of claim 11, wherein the program instructions are executable to:
create a story comprising a data structure that includes information defining the service, the impact urgency score, the scale-by value, and a date and time the scaling was performed;
save the story in a repository;
identify a pattern by analyzing plural stories saved in the repository as a time series; and
proactively scale the computing cluster running the workload based on the identified pattern.

15. The computer program product of claim 11, wherein the scaling comprises one of:
horizontal scaling of pods in the computing cluster running the workload that provides the service; and
vertical scaling of pods in the computing cluster running the workload that provides the service.

16. A system comprising:
a processor set, one or more computer readable storage media, and program instructions collectively stored on the one or more computer readable storage media, the program instructions executable to:
determine a service availability impact and a user tone associated with a service by analyzing one or more electronic communications using natural language processing;
determine an impact urgency score based on the service availability impact and the user tone;
determine a scale-by value based on the impact urgency score; and
scale, based on the scale-by value, a computing cluster running a workload that provides the service.

17. The system of claim 16, wherein the impact urgency score is additionally based on an urgency value derived from a total number of the one or more electronic communications.

18. The system of claim 16, wherein the analyzing one or more electronic communications comprises detecting a service keyword, a service availability keyword, and a tone keyword in the one or more electronic communications.

19. The system of claim 16, wherein the program instructions are executable to:
create a story comprising a data structure that includes information defining the service, the impact urgency score, the scale-by value, and a date and time the scaling was performed;
save the story in a repository;
identify a pattern by analyzing plural stories saved in the repository as a time series; and
proactively scale the computing cluster running the workload based on the identified pattern.

20. The system of claim 16, wherein the scaling comprises one of:
horizontal scaling of pods in the computing cluster running the workload that provides the service; and
vertical scaling of pods in the computing cluster running the workload that provides the service.
